(19) United States
(12) Patent Application Publication
(10) Pub. No.: US 2009/0295736 A1
(43) Pub. Date: Dec. 3, 2009

(54) DEVICE HAVING AND METHOD FOR PROVIDING A GEMSTONE KEYMAT

(75) Inventors: Kristopher Laurent, London (GB); Caroline Millar, Bramely (GB)

Correspondence Address: Perman & Green, LLP, 99 Hawley Lane, Stratford, CT, 06614, US

(73) Assignee: NOKIA CORPORATION, Nokia Group (FI)

(21) Appl. No.: 12/129,287

(22) Filed: May 29, 2008

(51) Int. Cl. G06F 3/02

(52) U.S. Cl. 345/169

(57) ABSTRACT

A key includes a key body made of sapphire and a supporting body made of a silicone elastomer. The key body is bonded through a physical vapour deposition layer to the supporting body.

### FIELD

The present application relates to a device and a method for providing an aesthetically pleasing key, and in particular to a device and a method for bonding a key body to a supporting body.

### BACKGROUND

More and more electronic devices such as mobile phones, MP3 players, Personal Digital Assistants (PDAs) are becoming more and more fashion accessories and social statements and as such have higher requirements for having an aesthetically pleasing appearance and the visual appearance also needs to be more robust and durable.

Some device casings comprise precious materials such as semi precious stones, gem stones, mineral (sapphire for example) or crystal stones embedded in the casing. This has the disadvantage that the casing needs to have a thickness ample enough to accommodate a stone and the gem stone can also become dislodged and fall out if not handled carefully. Portable devices such as mobile phones are usually not treated carefully as they are often carried around in bags or pockets where they come in contact with other devices such as keys, credit cards, lighters etc. When in contact with such things a gem stone may become dislodged. It is also difficult during assembly to put the gem stones into their little holes.

A device that has an aesthetic appearance and which is durable and robust to outer wear and tear and that is easy to assemble would thus be useful in modern day society.

### SUMMARY

On this background, it would be advantageous to provide a device and a method that overcomes or at least reduces the drawbacks indicated above by providing a key wherein a key body is bonded to a supporting body through the use of a physical vapor deposition layer(s).

The disclosed embodiments provide a key comprising a key body and a supporting body wherein said key body and said supporting body are bonded through a physical vapour deposition layer.

Using physical vapour deposition provides for an easy manner of manufacturing keys made of materials that are normally not easy to bond and to provide a low profile key having precious or semi-precious materials such as stones embedded and also to provide a key which is scratch resistant and thus will remain aesthetically pleasing and legible even though exposed to much wear and tear.

In one embodiment the physical vapour deposition (PVD) layer comprises a graphical pattern. As the PVD layers are thin they can be used to assign a graphical pattern to a key indicating the functionality of the key without requiring expensive engraving which could also decrease the strength of the key.

In one embodiment the physical vapour deposition layer comprises a reflective or semi reflective layer. Such a layer further increases the legibility of the key and increases the aesthetic properties of the key.

In one embodiment the physical vapour deposition layers can be made to provide different colours for the key body and graphics. Such colouring increases the aesthetic properties of the key.

In one embodiment a printed ink layer can be applied to the physical vapour deposition layer. The printed ink layer can be made to provide different colourings to the graphics. Such colouring increases the aesthetic properties of the key.

In one embodiment the physical deposition layer can be plated with a metal such as gold. This allows the key to be bonded to another metal supporting body by a method such as soldering.

In one embodiment the physical vapour deposition layer comprises an adhesive layer. This has the advantage that the bonding of the key body to the supporting body can be made very thin and will also be able to provide low profile keypads.

In one embodiment the adhesive layer comprises a bonding surface configured to be bonded to a supporting body.

A physical vapour deposition layer can beneficially be used to apply a thin bonding surface, preferably of metal, that can easily be bonded to a supporting surface. There are plenty of well known adhesives for bonding metal and silicone elastomers, whereas it is more difficult to bond a stone such as sapphire to a silicon using adhesives.

In one embodiment the key body is made of mineral, crystal, semi precious or precious gem stone for example sapphire, transparent ceramic or glass.

In one embodiment the supporting body is a silicone elastomer.

In one embodiment the supporting body is a plastic for example a polycarbonate.

In one embodiment the supporting body is a metal.

In one embodiment the bonding surface is bonded to a supporting body through soldering.

In one embodiment the bonding layer comprises a printed ink layer.

The aspects of the disclosed embodiments are also directed to providing a keypad comprising a plurality of keys according to above.

In one embodiment the keypad further comprises a mask arranged between at least two of said plurality of keys.

The aspects of the disclosed embodiments are also directed to providing a device comprising or arranged to comprise a key or according to above.

In one embodiment such a device is one of the following: a mobile communications terminal, a game console, a watch, a personal digital assistant, a camera or a media player.

The aspects of the disclosed embodiments are also directed to providing a method for manufacturing a key comprising bonding a key body to a supporting body through applying a physical vapour deposition layer to said supporting body and said key body.

A key produced through such a method shares the same advantages as has been explained above.

In one embodiment the method according to above, further comprises applying a bonding surface to said physical vapour layer.

In one embodiment the method according to above, further comprises applying a graphical pattern to said physical vapour deposition layer.

In one embodiment the method according to above, further comprises applying a reflective layer to said physical vapour deposition layer.

The aspects of the disclosed embodiments are also directed to providing an apparatus incorporating and implementing a method according to above.

The aspects of the disclosed embodiments are also directed to providing a key comprising a key body and a supporting member and physical vapour deposition means for bonding said key body to said supporting member body.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a plane front view of a device according to an embodiment,

FIG. 3 is a block diagram illustrating the general architecture of a device of FIG. 2 in accordance with the present application,

FIGS. 4a and b are schematic views of a key according to an embodiment,

FIG. 5 is a schematic cut out view of a key pad according to an embodiment,

FIG. 6 is a flow chart describing a method according to an embodiment.

### DETAILED DESCRIPTION

In the following detailed description, the device and the method according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices designed to have an exclusive appearance.

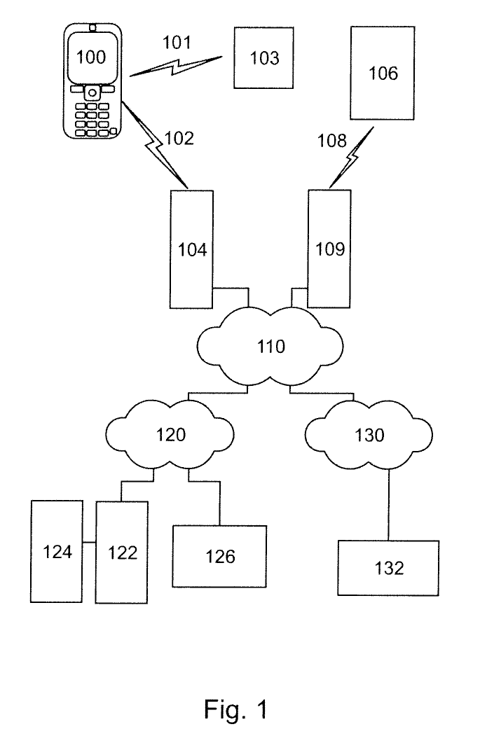

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency, RF links 102, 108 via base stations 104, 109. The mobile telecommunications network 110 may be in compliance with any commercially available mobile telecommunications standard, such as Group Speciale Mobile, GSM, Universal Mobile Telecommunications System, UMTS, Digital Advanced Mobile Phone system, D-AMPS, The code division multiple access standards CDMA and CDMA2000, Freedom Of Mobile Access, FOMA, and Time Division-Synchronous Code Division Multiple Access, TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

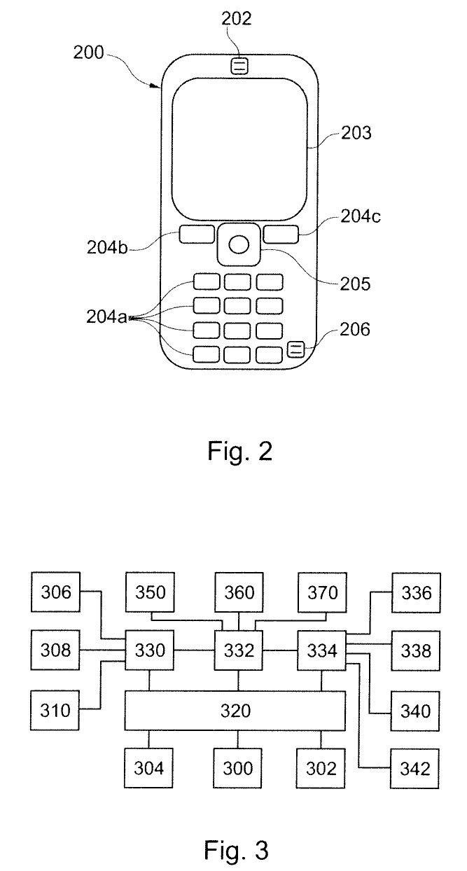

An embodiment 200 of the mobile terminal 100 is illustrated in more detail in FIG. 2. The mobile terminal 200 comprises a speaker or earphone 202, a microphone 206, a main or first display 203 and a set of keys 204 which may include a keypad 204a of common ITU-T type (alpha-numerical keypad representing characters “0”-“9”, “*” and “#”) and certain other keys such as soft keys 204b, 204c and a joystick 205 or other type of navigational input device.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”)), DSP (“Digital Signal Processor”)) or any other electronic programmable logic device. The controller 300 has associated electronic memory 302 such as Random Access Memory (RAM) memory, Read Only memory (ROM) memory, Electrically Erasable Programmable Read-Only Memory (EEPROM) memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application

The MMI 334 also includes one or more hardware controllers, which together with the MMI drivers cooperate with the first display 336/203, and the keypad 338/204 as well as various other Input/Output devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory.

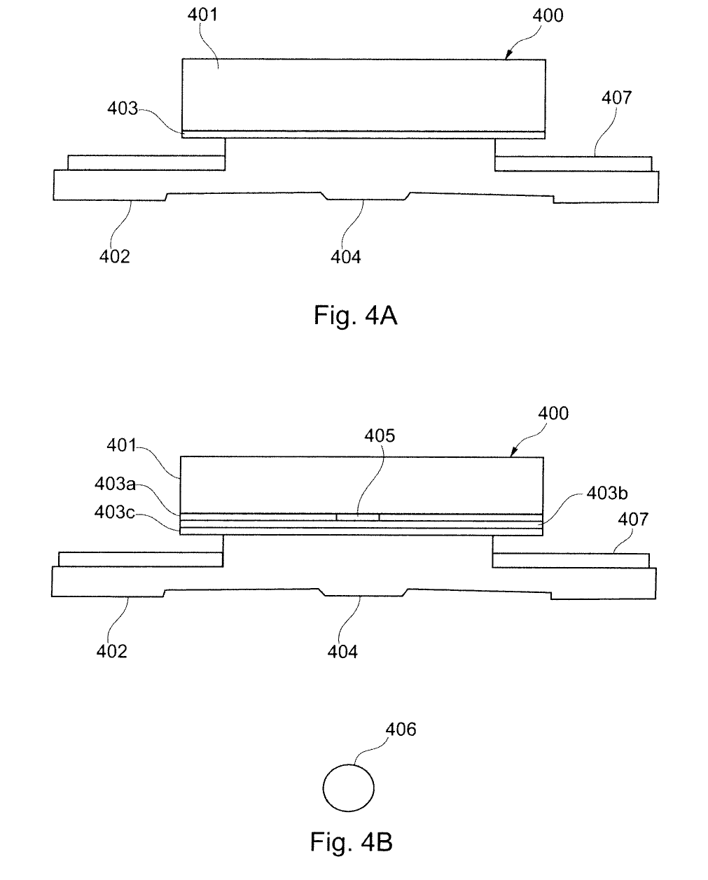

FIG. 4 shows a schematic view of a key 400 according to an embodiment. The key shown in FIG. 4A a key comprises a key body 401 made entirely of sapphire which is bonded to a supporting body 402 in this embodiment a silicone elastomer body through a Physical Vapor Deposition, PVD bonding layer 403. As will be described below this bonding layer 403 comprises a bonding surface and incorporates colors and graphics.

The silicone elastomer is flexible and has a protrusion 404 which is configured to interact with a key dome (not shown) so that as the key is pressed the silicone elastomer is deformed to convey the pressing force to a key dome which actuates the key press on a device.

The PVD bonding layer 403 is a very thin layer and is beneficially used in this embodiment as it serves both to bond the sapphire key body 401 to the silicone elastomer 402 and also to provide a color and/or graphical pattern to the key 400. The graphical pattern is achieved by masking or eroding the PVD layer for example using lasers as is commonly known.

FIG. 4B shows a detailed view of the PVD layer 403, and it should be noted that although it is shown here as three separate layers, it can be implemented as one, two or three layers. Closest to the key body 401 is a graphical layer 403a which has been masked to produce a graphical pattern to the key 400. In this embodiment this is illustrated by a clear portion 405 in the middle of the layer 403a. The graphical layer 403a is in this embodiment an opaque layer that has had certain portions masked and etched away. It should be understood that any graphical pattern such as a character or symbol can be generated in this way. Other methods of generating the graphical pattern can be etching or lasering.

Under the graphical layer 403a there is arranged a semi reflective layer 403b to further increase the legibility of the key as light passing through the key body 401 and the graphical pattern layer 403a will be reflected back to a user's eye and the reflective layer 403b also obscure the underlying structure so that it can not be seen from outside of the key 400. In this embedment this light source is a light emitting diode, an LED, but can also be implemented through the use of a light guide.

In this embodiment the reflective layer is 30% reflective and 70% transparent. Other embodiments can use other relationships for the reflection/transparency and the teachings of this document is not to be understood as being limited to 30% reflective and 70% transparent.

In one embodiment the graphical pattern is applied directly to the reflective or semi-reflective layer by screen printing the graphical pattern directly on to the reflective layer.

Closest to the silicone elastomer 402 there is an adhesive layer 403c which serves as the actual bonding between the key body 401 and the silicone elastomer body 402.

In one embodiment the adhesive layer is comprised by a bonding surface and a bonding agent, such as an adhesive.

In one embodiment the adhesive layer 403c provides a bonding surface to which a bonding agent, such as an adhesive, can be applied for bonding to the silicon elastomer 402.

The bonding surface can be of metal which provides a good surface for bonding with the silicone elastomer through the use of an adhesive.

In one embodiment the bonding surface is the underside of the reflective layer 403b. As metals are reflective and the bonding surface is preferably of metal it is cost efficient to provide the bonding surface as the underside of a metallic reflective surface as most metals are also reflective. In such an embodiment the adhesive layer 403c is not a PVD layer, but simply a layer made of an adhesive.

As the PVD layer 403 is so thin a light source 406 emanating from underneath the key 400 is used in this embodiment to illuminate the key 400 as the light easily penetrates the thin PVD layer 403.

In this embodiment a protective layer 407 is provided above the silicone elastomer body 402 to provide both extra strength and rigidity to the key and also to provide dust and humidity protection for the underlying structure. The protective layer 407 also serves to hide the internal structure of a keypad or a device incorporating such a key and is in this embodiment implemented with a mask film. This is particularly useful if the key body 401 extends beyond the PVD layer 403 in which case the areas between the PVD layers would be visible to a user which could lower the aesthetic properties of such a device. In this embodiment the protective layer 407 is gold plated to further the aesthetic properties of the key.

In one embodiment (not shown) there is an additional layer under the graphical layer 403a which serves to further the aesthetic properties of the key. In one embodiment this additional layer is gold plated to further the exclusivity of the key and a device incorporating such a key. In such an embodiment the sapphire key body 401 can be soldered onto a metal key mat.

In one embodiment the supporting body is a metal.

In one embodiment the bonding surface is bonded to a supporting body through soldering. Soldering is especially beneficial when the supporting surface is made of metal, but can also be used for bonding plastics as is known.

In one embodiment the bonding layer comprises a printed ink layer.

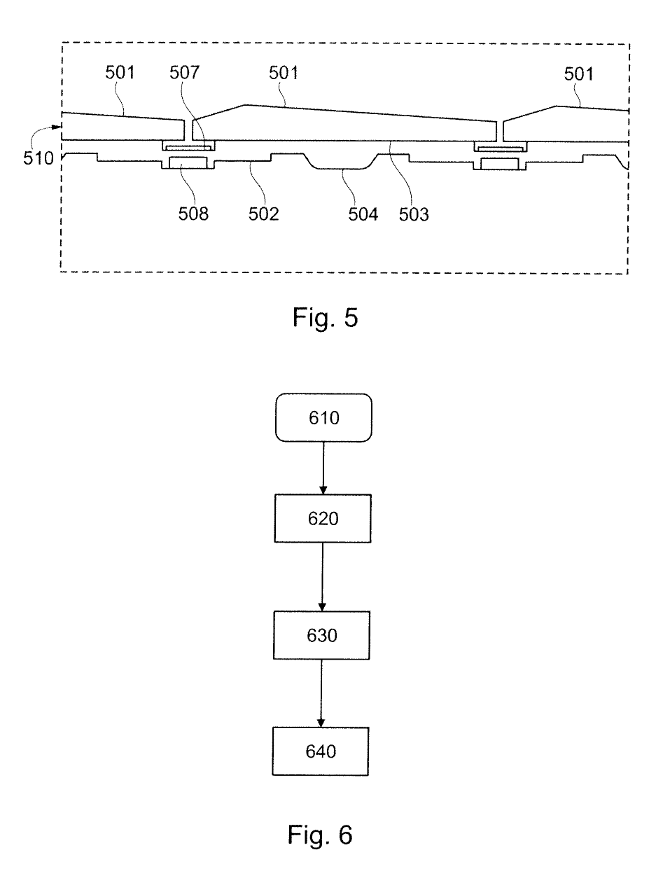

FIG. 5 shows a section of a keypad 510 according to an embodiment. An array of key bodies 501 made of sapphire are aligned over a silicone elastomer body 502. Arranged under each key body 501 is a protrusion 504 configured to co-operate with a key dome (not shown). As can be seen the key bodies 501 extend beyond the PVD layers 503 and between each key body 501 there is arranged a protective layer or mask film 507. To increase the rigidity of the keypad a reinforcement structure 508 is used. In this embodiment it is a metallic ring extending around each protrusion thus effectively making each key body's underlying portion of silicone elastomer 402 rigid in the vicinity of that key. In this embodiment the silicone elastomer body 402 is shared between all the keys 401 in the keypad 510.

Having key bodies 501 made of sapphire ensure that the aesthetic properties of a device remain appealing and they also provide scratch proof keys which will remain legible even after much wear and tear.

Manufacturing such a key or keypad can beneficially be implemented by applying a combined bonding and graphical pattern layer using PVD techniques. This provides for a quick and easy way of manufacturing that also is easy to change according to design criteria to accommodate for different key forms, patterns and colors.

FIG. 6 shows a method of manufacturing a key as above. It should be noted that the order of the steps can be shuffled and for example the reverse order of steps 610 to 630 could be used. In a first step 610 a graphical layer is formed on or applied to a sapphire key body. This layer is formed using physical vapor deposition and the graphical pattern is formed through a masking or an etching process as is commonly known.

It should be noted that there may be many different combinations of layers of PVD and also printing that can be used to build up the layer structure. Combining PVD layers in semitransparent and opaque layers can result in a good bonding surface with graphics and colors.

A semi reflective layer is then applied to the graphical pattern in a second step 620 and in a third step 630 an adhesive layer is applied to the key body and in a final step 640 the key body is bonded to a silicone elastomer through the applied PVD layers.

The various aspects of what is described above can be used alone or in various combinations. It should be noted that the teaching of this application is not limited to the use in mobile communication terminals such as mobile phones, but can be equally well applied in Personal digital Assistants (PDAs), game consoles, MP3 players, personal organizers or any other device designed for prolonged use while still maintaining an easy to perceive user interface and maintain an aesthetic appeal.

The teaching of the present application has numerous advantages. Different embodiments or implementations may yield one or more of the following advantages. It should be noted that this is not an exhaustive list and there may be other advantages which are not described herein. For example, one advantage of the teaching of this application is that it is possible to incorporate precious materials such as stones in a device without increasing its thickness.

Another exemplary advantage of the teaching of the present application is that the aesthetic properties of such a device are increased.

Another exemplary advantage of the teaching of the present application is that such a key will be more durable and legible even after much wear and tear.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “aa” or “an” as used in the claims does not exclude a plurality. A unit or other means may fulfill the functions of several units or means recited in the claims.

1. A key comprising a key body and a supporting body wherein said key body and said supporting body are bonded through a physical vapour deposition layer.

2. A key according to claim 1, wherein said physical vapour deposition layer comprises a graphical pattern.

3. A key according to claim 1, wherein said physical vapour deposition layer comprises a reflective or semi reflective layer.

4. A key according to claim 1, wherein said physical vapour deposition layer comprises an adhesive layer.

5. A key according to claim 1, wherein said adhesive layer comprises a bonding surface configured to be bonded to a supporting body.

6. A key according to claim 1, wherein said key body is made of mineral, crystal, semi precious or gem stone.

7. A key according to claim 6, wherein said key body is made of sapphire.

8. A key according to claim 1, wherein said supporting body is a silicone elastomer or a plastic.

9. A keypad comprising a plurality of keys according to claim 1.

10. A keypad according to claim 9, comprising a mask arranged between at least two of said plurality of keys.

11. A device comprising or arranged to comprise a key according to claim 1.

12. A device comprising or arranged to comprise a keypad according to claim 9.

13. A method for manufacturing a key comprising bonding a key body to a supporting body through applying a physical vapour deposition layer to said supporting body and said key body.

14. A method according to claim 13, further comprising applying a bonding surface to said physical vapour layer.

15. A method according to claim 13, further comprising applying a graphical pattern to said physical vapour deposition layer.

16. A method according to claim 13, further comprising applying a reflective layer to said physical vapour deposition layer.

17. An apparatus incorporating and implementing a method according to claim 13

18. A key comprising a key body and a supporting member and physical vapour deposition means for bonding said key body to said supporting member body through providing a bonding surface to be bonded to said supporting member.
